(19) United States
(12) Patent Application Publication
(10) Pub. No.: US 2009/0165826 A1
(43) Pub. Date: Jul. 2, 2009

(54) Washing device for recyclable containers

(76) Inventor: Michel Proulx, Montreal (CA)

Correspondence Address: INVENTARIUM, 4050, ROSEMONT, SUITE 1607, MONTREAL, QC, H1X1M4, CA

(21) Appl. No.: 11/855,317

(22) Filed: Sep. 14, 2007

(51) Int. Cl. B08B 9/08

(52) U.S. Cl. 134/22.1; 134/166 R

(57) ABSTRACT

A washing device for recyclable container comprises a base from which perpendicularly extends a stand. A hose connected to a faucet. The hose connects to a connector. A sub hose connects the connector to a spray tube base from which integrally extends the spray tube. A sliding arm is rotationally connected to the spray tube base. The sliding arm extends from the stand so as to interface between the spray tube base and the stand. The spray tube is terminated at its upper end by a nozzle from which emerges water. A valve actuator located on the spray tube base is actuated by way of a stem extending therefrom. The valve actuator is mechanically connected to a valve.

### FIELD OF THE INVENTION

The present invention relates generally to washing devices but more particularly to a washing device for recyclable containers.

### BACKGROUND OF THE INVENTION

Many devices exist for bars and which are specifically designed to wash drinking glasses. There are also many devices used for washing dishes.

In view of the increasing demands for recycling and the fact that many recycling centers demand that containers be rinsed before being sent to recycling, there is a need for a practical device aimed at facilitating the washing and rinsing of containers.

### SUMMARY OF THE INVENTION

In view of the foregoing disadvantages inherent in the known devices now present in the prior art, the present invention, which will be described subsequently in greater detail, is to provide objects and advantages which are:

To provide for a low cost washing device for recyclable containers.

To provide for an easy to install device for recyclable containers.

To provide for an easy to use device for recyclable containers.

To provide for a device that rinses better.

To provide for a device that wastes less water.

In order to do so, the invention comprises a base from which perpendicularly extends a stand. A hose connected to a faucet. The hose connects to a connector. A sub hose connects the connector to a spray tube base from which integrally extends the spray tube. A sliding arm is rotationally connected to the spray tube base. The sliding arm extends from the stand so as to interface between the spray tube base and the stand. The spray tube is terminated at its upper end by a nozzle from which emerges water. A valve actuator located on the spray tube base is actuated by way of a stem extending therefrom. The valve actuator is mechanically connected to a valve.

In a variation of the embodiment, the spray tube can rotate in relation to the sliding arm to accommodate containers of varying sizes.

In yet another variation of the embodiment, the base consists of individual feet.

In yet another variation of the embodiment, the base has feet that are telescoping.

In yet another variation of the embodiment, the base has feet that are terminated by suction cups.

Preferably, a ball is located at the upper end of the stand serves to hold and stabilize the base.

To facilitate insertion of containers, the stem has casters.

The washing device for recyclable container has the method of use consisting of the steps of:

putting the washing device for recyclable container inside a sink or related type tub or basin.

a user installs a container so that the spray tube is nested inside the container and the stem located outside of the container.

the container thus installed depresses the stem which actuates the valve actuator which opens the valve, which brings water to the nozzle.

water is sprayed inside the container so as to wash and rinse it.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. For example, a pump can be added to provide for more water pressure in more demanding situations. Also, it is to be understood that the phraseology and terminology employed herein are for the purpose of description and should not be regarded as limiting.

As such, those skilled in the art wilt appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Side view of the device.

FIG. 2 Side view of the device in context of use.

FIG. 3 Front view of the device.

FIG. 4 Isometric detail of the fixed arm and the telescoping arm.

FIG. 5 Top view of the device showing extendible legs.

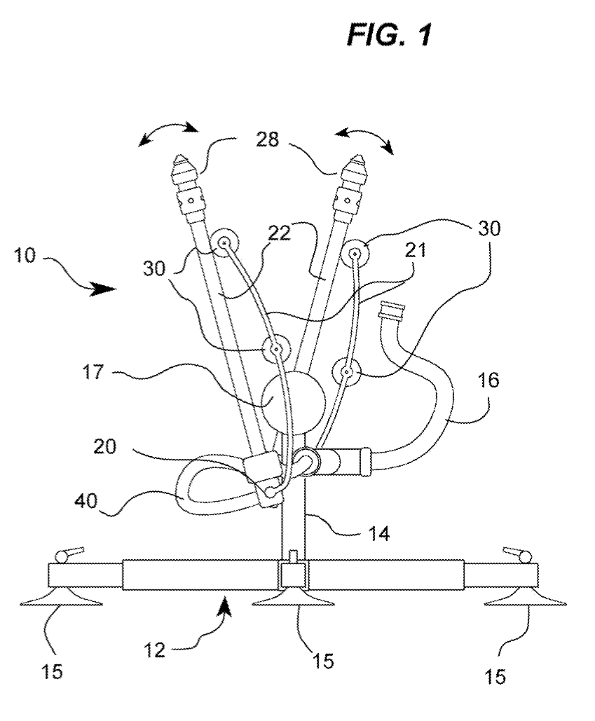

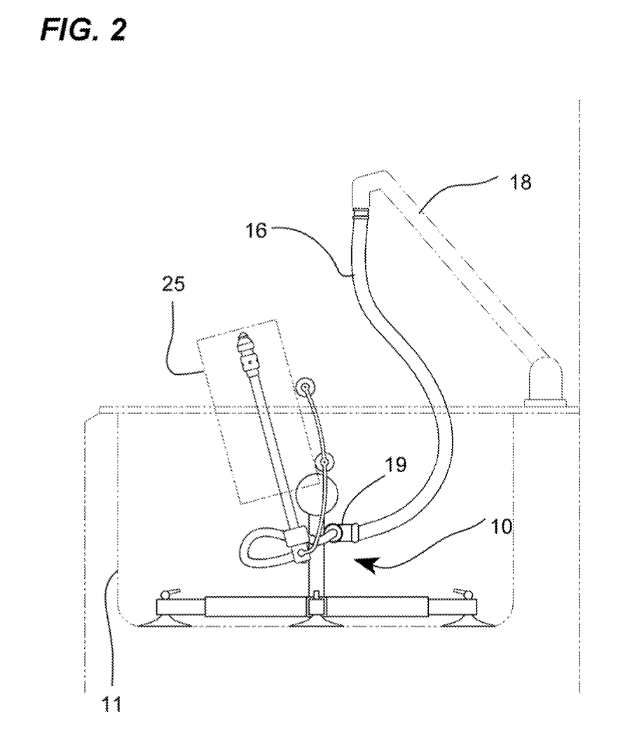

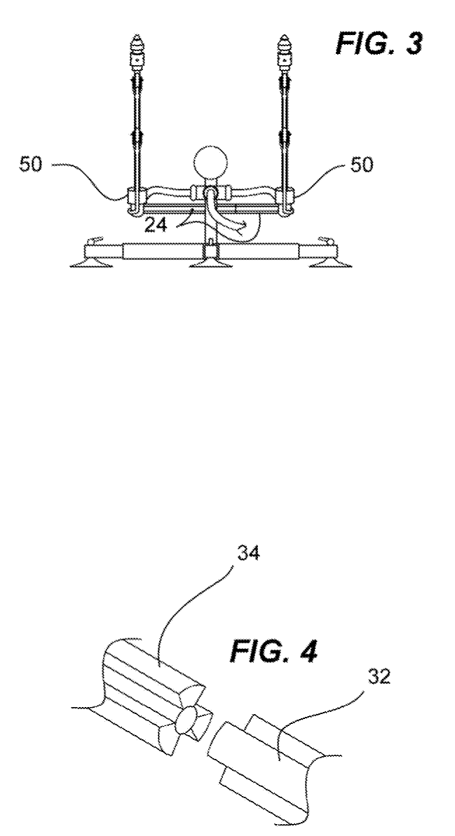

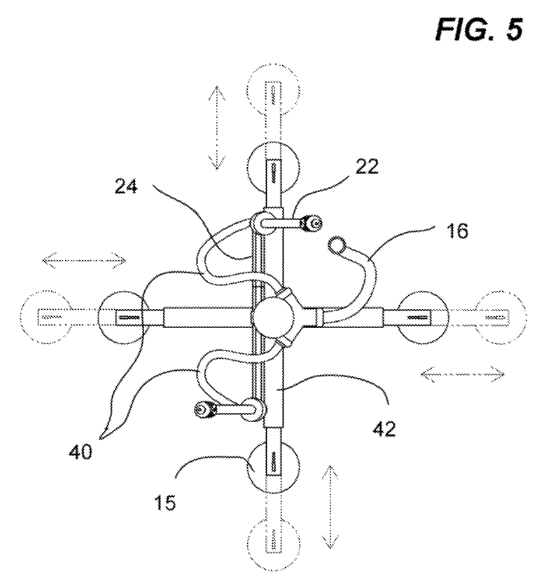

### DETAILED DESCRIPTION

A washing device for recyclable container (10) has a base (12) from which perpendicularly extends a stand (14).

The washing device for recyclable container (10) is preferably placed inside a sink (11) and has a hose (16) connected to a faucet (18).

A spray tube (22) is terminated at its upper end by a nozzle (28) from which emerges water. The spray tube (22) can rotate in relation to the sliding arm (24) to accommodate containers (25) of varying sizes. Also, the nozzle (28) can have adjustable flow rates as well as a rotational spray head. These types of nozzles are known in the art and need not be further discussed herein.

The base (12) consists of individual feet (42) which can optionally be telescoping in nature and which can be terminated by suction cups (15) to hold the washing device for recyclable container (10) inside a sink (11) or any such location. Suction cups and telescoping feet are known in the art so no further details is needed. A ball (17) is located at the upper end of a stand (14) and is used for pressing the washing device for recyclable container (10) down so that the suction cup (15) can be effectively installed, it also serves to hold and stabilize the washing device for recyclable container (10) since water pressure and the installing and removal of the containers being washed could otherwise displace the washing device for recyclable container (10).

The hose (16) is connected to the faucet (18) at one end and to a connector (19) at its opposite end. The connector (19) is “Y” shaped when there are two spray tubes (22). From the opposite end of the connector (19) extends at least one sub hose (40), two sub hoses (40) if the connector is “Y” shaped and more sub hoses (40) if there are more than two spray tubes (22). The sub hose (40) connects the connector (19) to the spray tube base (50). The spray tube base (50) has the spray tube (22) extending therefrom.

A valve actuator (20) is actuated by way of a stem (21) extending therefrom. The action of inserting a container pushes against casters (30) actuated by inserting a container between the stem (21) and the spray tube (22). The valve actuator (20) is mechanically connected to the valve itself which is not shown since it is located inside the spray tube's base (23). The inner workings of the valve and the manner in which the valve actuator (20) interacts with the valve itself is derived from methods well known in the art and need not be discussed herein.

At least one sliding arm (24) extends from the stand (14) and can slide sideways, so as to allow the spray tube (22) to move sideways to allow for larger containers to fit in without conflicting with other parts. The sliding arm (24) consists in two parts, a fixed arm (32) and a telescoping arm (34) as best seen in FIG. 4.

In an alternate embodiment, the washing device for recyclable container (10) can have only one spray tube (22). Of course, there could also be more than two spray tubes (22) without departing from the scope of the invention.

In order to use the washing device for recyclable container (10), it is put inside a sink (11) or related type tub or basin so that sprayed water will be collected. In order to use the washing device for recyclable container (10), a user installs a container so that the spray tube (22) is nested inside the container and the stem (21) located outside of the container. The action of inserting the container in such a manner depresses the stem (21) which actuates the valve actuator (20) which opens the valve, which brings water to the nozzle (28). The water is sprayed inside the container (25) so as to wash and rinse it.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A washing device for recyclable container comprising:
a base from which perpendicularly extends a stand;
a hose connected to a faucet;
the hose connects to a connector;
a sub hose connects the connector to a spray tube base from which integrally extends the spray tube
a sliding arm rotationally connected to the spray tube base;
the sliding arm extending from the stand so as to interface between the spray tube base and the stand;
the spray tube terminated at its upper end by a nozzle from which emerges water;
a valve actuator located on the spray tube base is actuated by way of a stem extending therefrom;
the valve actuator is mechanically connected to a valve.

2. A washing device for recyclable container comprising as in claim 1 wherein:
the spray tube can rotate in relation to the sliding arm to accommodate containers of varying sizes.

3. A washing device for recyclable container comprising as in claim 1 wherein:
the base consists of individual feet.

4. A washing device for recyclable container comprising as in claim 1 wherein:
the base has feet that are telescoping.

5. A washing device for recyclable container comprising as in claim 1 wherein:
the base has feet that are terminated by suction cups.

6. A washing device for recyclable container comprising as in claim 1 wherein:
the base consists of individual feet that are telescoping and terminated by suction cups

7. A washing device for recyclable container comprising as in claim 1 wherein:
a ball is located at the upper end of the stand serves to hold and stabilize the base.

8. A washing device for recyclable container comprising as in claim 1 wherein:
the stem has casters.

9. A washing device for recyclable container as in claim 1 having the method of use consisting of the steps of:
putting the washing device for recyclable container inside a sink or related type tub or basin;
a user installs a container so that the spray tube is nested inside the container and the stem located outside of the container;
the container thus installed depresses the stem which actuates the valve actuator which opens the valve, which brings water to the nozzle;
water is sprayed inside the container so as to wash and rinse it.
